(19) United States
(12) Patent Application Publication
(10) Pub. No.: US 2020/0124002 A1
(43) Pub. Date: Apr. 23, 2020

(54) GAS TURBINE ENGINE

(71) Applicants: Rolls-Royce Deutschland Ltd & Co KG, Blankenfelde-Mahlow (DE); Rolls-Royce plc, London (GB)

(72) Inventors: Stephan UHKOETTER, Berlin (DE); Uwe KRACHT, Berlin (DE); David WILLIAMS, Bristol (GB)

(21) Appl. No.: 16/539,412

(22) Filed: Aug. 13, 2019

(30) Foreign Application Priority Data
Aug. 22, 2018 (DE) 102018120511.2

(51) Int. Cl. F02K 3/06; F02C 7/36

(52) U.S. Cl. CPC F02K 3/06; F02C 7/06; F02C 7/36

(57) ABSTRACT

A gas turbine engine for an aircraft having a gearbox that can be supplied with oil via an oil system is described. The oil supplied to the gearbox can be fed back into the oil system via a return of the gearbox and can be supplied to a feed of the gearbox again via the oil system. The oil system furthermore has an oil filter between the return and the feed of the gearbox for the purpose of filtering dirt particles out of the oil introduced into the oil system from the return. In the region of the oil filter, oil that has been cleaned can be guided in the direction of the feed of the gearbox. Oil can be passed through the oil filter to wash dirt particles out of the oil filter.

This application claims priority to German Patent Application DE102018120511.2 filed Aug. 22, 2018, the entirety of which is incorporated by reference herein.

The present disclosure relates to a gas turbine engine for an aircraft having a gearbox that can be supplied with oil via an oil system.

A gas turbine engine for an aircraft having an engine core is known from DE 10 2018 109 108.7 by the applicant, which is not a prior publication. The engine core comprises at least one turbine, at least one compressor and at least one shaft, which connects the turbine and the compressor to one another. Furthermore, the gas turbine engine is constructed with a fan, which is arranged downstream of the engine core. The fan has a large number of fan blades. In addition, the gas turbine engine is constructed with a gearbox, which can be supplied with oil by a first oil circuit and by at least one second oil circuit. The first oil circuit and the second oil circuit are connected to at least one inlet and to at least one outlet of the gearbox and to at least one inlet and to at least one outlet of an oil tank. Oil can be passed from the oil tank to the gearbox by the first oil circuit and the second oil circuit. A filter of the first oil circuit and/or of the second oil circuit can be arranged between a pump and the inlet of the gearbox, between the outlet of the gearbox and the inlet of the oil tank or between the outlet of the oil tank and the pump.

The present disclosure is based on the object of making available a gas turbine engine which is distinguished both by a high level of reliability and by a low outlay on maintenance.

According to a first aspect, a gas turbine engine for an aircraft having a gearbox that can be supplied with oil via an oil system is made available. The oil supplied to the gearbox can be fed back into the oil system via a return of the gearbox and can be supplied to the feed of the gearbox again via the oil system. The oil system furthermore has an oil filter between the return and the feed of the gearbox for the purpose of filtering dirt particles out of the oil introduced into the oil system from the return. Oil cleaned in the region of the oil filter can be guided in the direction of the feed of the gearbox. In addition, oil can be passed through the oil filter to wash dirt particles out of the oil filter, thereby providing a simple way of extending maintenance intervals and reducing the risk that the oil filter will be clogged.

In this case, the oil system can be embodied in such a way that the oil for washing out the dirt particles can be passed continuously and/or discontinuously through the oil filter.

The continuous washing of the oil filter with oil offers the possibility of avoiding an excessive rise in the loading of the oil filter with dirt particles during the entire operation of the gas turbine engine.

In contrast, discontinuous washing of the oil filter with oil in turn offers the possibility of supplying a gearbox oil supply with the required oil volume flow especially during operating state processes of the gas turbine engine during which the gearbox has a high oil requirement for cooling and lubrication. In operating states of the gearbox in which the oil requirement of the gearbox is low, it is additionally possible to pass oil through the oil filter to wash dirt particles out of the oil filter without impairing the oil supply to the gearbox.

If a valve unit is provided, by means of which oil can be passed through the oil filter to wash out dirt particles, discontinuous washing out of the oil filter can be achieved in a simple manner.

In an embodiment of the gas turbine engine which is distinguished by a low outlay on open-loop and closed-loop control, it is possible for the valve unit, depending on a pressure in the oil system between the return of the gearbox and the oil filter, to be transferred to an operating state in which dirt particles can be filtered out of the oil in the oil filter and oil can be passed through the oil filter to wash out dirt particles. In addition, it is also possible, depending on the pressure in the oil system between the return of the gearbox and the oil filter, for the valve unit to be transferred to a further operating state, in which it is only possible in the region of the oil filter to filter dirt particles out of the oil supplied to the oil filter from the return of the gearbox.

According to another aspect of the disclosure, a discontinuous washing mode of the oil filter can be achieved in accordance with the respectively present operating state of the gas turbine engine if the valve unit can be transferred under time and/or logic control to an operating state in which dirt particles can be filtered out of the oil in the oil filter and oil can be passed through the oil filter to wash out dirt particles. In addition, it is also possible for the valve unit to be transferred to a further operating state, in which it is only possible in the region of the oil filter to filter dirt particles out of the oil supplied to the oil filter from the return of the gearbox.

In this case, there is the possibility of transferring the valve unit to the operating state in which dirt particles can be filtered out of the oil in the oil filter and oil can be passed through the oil filter to wash out dirt particles after the expiry of a defined period of time. In addition, there is the possibility of varying this predefined period of time in accordance with a determined operating state process of the gas turbine engine.

Thus, there is the possibility, for example, of shortening the period of time if a permissible filtered oil quantity in the region of the oil filter is reached before the expiry of the defined period of time owing to an increased oil requirement of the gearbox. In contrast, provision can also be made for the predefined period of time to be lengthened if this permissible oil volume has been passed through the oil filter only after the expiry of the predefined period of time.

Moreover, there is also the possibility of starting or ending the washing out of the oil filter or of preventing activation of the washing out process in accordance with an oil temperature or in accordance with whether an aircraft constructed with the gas turbine engine is on the ground or in the air.

According to other aspects of the disclosure, a restriction device is provided respectively between the oil filter and the return and/or between the oil filter and the feed of the gearbox. The respective oil volume flow that can be passed through the oil filter in the direction of the feed of the gearbox and possibly that for the washing out of dirt particles can then be adjusted to a defined extent in a manner which is simple in terms of design.

If the oil system has an oil pump downstream of the return of the gearbox and upstream of the oil filter, the oil filter can be supplied with oil to the desired extent.

In embodiments of the gas turbine engine which are advantageous in terms of installation space, the oil filter is arranged at least partially within a housing of the gearbox.

If the oil filter is arranged outside the housing of the gearbox, this can, in turn, be checked or replaced with little effort during maintenance.

In an embodiment of the gas turbine engine which is simple in terms of design and inexpensive, the oil filter comprises a housing, in which a filter medium is arranged between an inlet of the housing, which is connected to the return of the gearbox, and an outlet of the housing. The outlet of the housing is connected to the feed of the gearbox. In addition, the housing comprises a further outlet, via which oil for washing dirt particles out of the filter medium can be discharged from the housing.

Moreover, provision can be made for the housing to be designed with a further inlet, by which oil for washing dirt particles out of the oil filter can be introduced into said housing.

In an embodiment of the gas turbine engine which is simple in terms of design and favorable in terms of installation space, the oil volume flow, by means of which dirt particles can be discharged from the oil filter, can be introduced into the return of the gearbox starting from the oil filter.

According to another aspect of the disclosure, the oil system is designed in such a way that the oil volume flow to be passed through the oil filter to wash out dirt particles can be supplied to the oil filter at least partially starting from the return of the gearbox. As a result, there is the possibility of embodying the oil filter with just one inlet, via which both the oil to be filtered in the region of the oil filter in the direction of the feed of the gearbox and the oil to be passed through the oil filter to wash dirt particles out of the oil filter can be introduced into the oil filter.

As noted elsewhere herein, the present disclosure may relate to a gas turbine engine. Such a gas turbine engine may comprise an engine core which comprises a turbine, a combustion chamber, a compressor, and a core shaft that connects the turbine to the compressor. Such a gas turbine engine may comprise a fan (having fan blades) which is positioned upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive for the fan so as to drive the fan at a lower rotational speed than the core shaft. The input to the gearbox may be performed directly from the core shaft or indirectly from the core shaft, for example via a spur shaft and/or a spur gear. The core shaft may be rigidly connected to the turbine and the compressor, such that the turbine and the compressor rotate at the same rotational speed (wherein the fan rotates at a lower rotational speed).

The gas turbine engine as described and claimed herein may have any suitable general architecture. For example, the gas turbine engine may have any desired number of shafts, for example one, two or three shafts, that connect turbines and compressors. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft which connects the second turbine to the second compressor. The second turbine, the second compressor, and the second core shaft may be arranged so as to rotate at a higher rotational speed than the first core shaft.

In such an arrangement, the second compressor may be positioned so as to be axially downstream of the first compressor. The second compressor may be arranged so as to receive (for example directly receive, for example via a generally annular duct) flow from the first compressor.

The gearbox may be arranged so as to be driven by the core shaft (for example the first core shaft in the example above) that is configured to rotate (for example during use) at the lowest rotational speed. For example, the gearbox may be arranged so as to be driven only by the core shaft (for example only by the first core shaft, and not the second core shaft, in the example above) that is configured to rotate (for example when in use) at the lowest rotational speed. Alternatively thereto, the gearbox may be arranged so as to be driven by one or a plurality of shafts, for example the first and/or the second shaft in the example above.

In the case of a gas turbine engine which is described and claimed herein, a combustion chamber may be provided so as to be axially downstream of the fan and the compressor(s). For example, the combustion chamber may lie directly downstream of the second compressor (for example at the exit of the latter), when a second compressor is provided. By way of further example, the flow at the exit of the compressor may be provided to the inlet of the second turbine, when a second turbine is provided. The combustion chamber may be provided so as to be upstream of the turbine(s).

The or each compressor (for example the first compressor and the second compressor as described above) may comprise any number of stages, for example multiple stages. Each stage may comprise a row of rotor blades and a row of stator vanes, the latter potentially being variable stator vanes (in that the angle of incidence of said stator vanes can be variable). The row of rotor blades and the row of stator blades may be axially offset from each other.

The or each turbine (for example the first turbine and the second turbine as described above) may comprise any number of stages, for example multiple stages. Each stage may comprise a row of rotor blades and a row of stator blades. The row of rotor blades and the row of stator blades may be axially offset from one another.

Each fan blade may be defined as having a radial span extending from a root (or a hub) at a radially inner location flowed over by gas, or at a 0% span width position, to a tip at a 100% span width position. The ratio of the radius of the fan blade at the hub to the radius of the fan blade at the tip may be less than (or on the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range delimited by two of the values in the previous sentence (that is to say that the values may form upper or lower limits). These ratios may be referred to in general as the hub-to-tip ratio. The radius at the hub and the radius at the tip can both be measured at the leading periphery (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centreline and the tip of the fan blade at the leading periphery of the latter. The diameter of the fan (which can simply be double the radius of the fan) may be larger than (or on the order of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range delimited by two of the values in the previous sentence (that is to say that the values may form upper or lower limits).

The rotational speed of the fan may vary during use. Generally, the rotational speed is lower for fans with a comparatively large diameter. Purely by way of nonlimiting example, the rotational speed of the fan at cruise conditions may be less than 2500 rpm, for example less than 2300 rpm. Purely by way of further non-limiting example, the rotational speed of the fan at cruise conditions for an engine having a fan diameter in the range from 250 cm to 300 cm (for example 250 cm to 280 cm) may also be in the range from 1700 rpm to 2500 rpm, for example in the range from 1800 rpm to 2300 rpm, for example in the range from 1900 rpm to 2100 rpm. Purely by way of further nonlimiting example, the rotational speed of the fan at cruise conditions for an engine having a fan diameter in the range from 320 cm to 380 cm may be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a speed Utip. The work done by the fan blades on the flow results in an enthalpy rise dH in the flow. A fan tip loading may be defined as dH/Utip2, where dH is the enthalpy rise (for example the 1-D average enthalpy rise) across the fan and Utip is the (translational) velocity of the fan tip, for example at the leading periphery of the tip (which may be defined as the fan tip radius at the leading periphery multiplied by the angular speed). The fan tip loading at cruise conditions may be more than (or on the order of): 0.3, 0.31, 0.32, 0.33, 0.34, 0.35, 0.36, 0.37, 0.38, 0.39, or 0.4 (wherein all units in this passage are Jkg-1K-1/(ms-1)2). The fan tip loading may be in an inclusive range delimited by two of the values in the previous sentence (that is to say that the values may form upper or lower limits).

Gas turbine engines in accordance with the present disclosure may have any desired bypass ratio, wherein the bypass ratio is defined as the ratio of the mass flow rate of the flow through the bypass duct to the mass flow rate of the flow through the core under cruise conditions. In the case of some arrangements, the bypass ratio may be more than (or on the order of): 10, 10.5, 11, 11.5, 12, 12.5, 13, 13.5, 14, 14.5, 15, 15.5, 16, 16.5, or 17. The bypass ratio may be in an inclusive range delimited by two of the values in the previous sentence (that is to say that the values may form upper or lower limits). The bypass duct may be substantially annular. The bypass duct may be situated radially outside the engine core. The radially outer surface of the bypass duct may be defined by an engine nacelle and/or a fan casing.

The overall pressure ratio of a gas turbine engine as described and claimed herein may be defined as the ratio of the stagnation pressure upstream of the fan to the stagnation pressure at the exit of the highest pressure compressor (before the entry to the combustion chamber). By way of non-limiting example, the overall pressure ratio of a gas turbine engine as described and claimed herein at cruising speed may be greater than (or on the order of): 35, 40, 45, 50, 55, 60, 65, 70, 75. The overall pressure ratio may be in an inclusive range delimited by two of the values in the previous sentence (that is to say that the values may form upper or lower limits).

The specific thrust of a gas turbine engine may be defined as the net thrust of the gas turbine engine divided by the total mass flow through the engine. The specific thrust of an engine as described and/or claimed herein at cruise conditions may be less than (or on the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range delimited by two of the values in the previous sentence (that is to say that the values may form upper or lower limits). Such gas turbine engines can be particularly efficient in comparison with conventional gas turbine engines.

A gas turbine engine as described and claimed herein may have any desired maximum thrust. Purely by way of a non-limiting example, a gas turbine as described and/or claimed herein may be capable of generating a maximum thrust of at least (or on the order of): 160 kN, 170 kN, 180 kN, 190 kN, 200 kN, 250 kN, 300 kN, 350 kN, 400 kN, 450 kN, 500 kN, or 550 kN. The maximum thrust may be in an inclusive range delimited by two of the values in the previous sentence (that is to say that the values may form upper or lower limits). The thrust referred to above may be the maximum net thrust at standard atmospheric conditions at sea level plus 15 degrees C. (ambient pressure 101.3 kPa, temperature 30 degrees C.) in the case of a static engine.

In use, the temperature of the flow at the entry to the high-pressure turbine can be particularly high. This temperature, which can be referred to as TET, may be measured at the exit to the combustion chamber, for example directly upstream of the first turbine blade, which in turn can be referred to as a nozzle guide blade. At cruising speed, the TET may be at least (or on the order of): 1400K, 1450K, 1500K, 1550K, 1600K, or 1650K. The TET at cruising speed may be in an inclusive range delimited by two of the values in the previous sentence (that is to say that the values can form upper or lower limits). The maximum TET in the use of the engine may be at least (or on the order of), for example: 1700K, 1750K, 1800K, 1850K, 1900K, 1950K, or 2000K. The maximum TET may be in an inclusive range delimited by two of the values in the previous sentence (that is to say that the values may form upper or lower limits). The maximum TET may occur, for example, under a high thrust condition, for example under a maximum take-off thrust (MTO) condition.

A fan blade and/or an airfoil portion of a fan blade as described herein can be manufactured from any suitable material or a combination of materials. For example, at least a part of the fan blade and/or of the airfoil may be manufactured at least in part from a composite, for example a metal matrix composite and/or an organic matrix composite, such as carbon fibre. By way of a further example, at least a part of the fan blade and/or of the airfoil may be manufactured at least in part from a metal, such as a titanium-based metal or an aluminum-based material (such as an aluminum-lithium alloy) or a steel-based material. The fan blade may comprise at least two regions which are manufactured using different materials. For example, the fan blade may have a protective leading periphery, which is manufactured using a material that is better able to resist impact (for example of birds, ice, or other material) than the rest of the blade. Such a leading periphery may, for example, be manufactured using titanium or a titanium-based alloy. Thus, purely by way of example, the fan blade may have a carbonfiber-based or aluminum-based body (such as an aluminum-lithium alloy) with a titanium leading periphery.

A fan as described herein may comprise a central portion from which the fan blades can extend, for example in a radial direction. The fan blades may be attached to the central portion in any desired manner. For example, each fan blade may comprise a fixing device which can engage with a corresponding slot in the hub (or disk). Purely by way of example, such a fixing device may be in the form of a dovetail that can be inserted into and/or engage with a corresponding slot in the hub/disk in order for the fan blade to be fixed to the hub/disk. By way of a further example, the fan blades may be formed integrally with a central portion. Such an arrangement may be referred to as a blisk or a bling. Any suitable method may be used to manufacture such a blisk or such a bling. For example, at least a part of the fan blades may be machined from a block and/or at least a part of the fan blades may be attached to the hub/disk by welding, such as linear friction welding.

The gas turbine engines as described and claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine engine as described and claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or the gas turbine engine at the midpoint (in terms of time and/or distance) between end of climb and start of descent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example in the region of 11,000 m. The cruise conditions may correspond to standard atmospheric conditions at any given altitude in these ranges.

Purely by way of example, the cruise conditions may correspond to the following: a forward Mach number of 0.8; a pressure of 23,000 Pa; and a temperature of −55 degrees C.

As used anywhere herein, “cruising speed” or “cruise conditions” may mean the aerodynamic design point. Such an aerodynamic design point (or ADP) may correspond to the conditions (including, for example, the Mach number, environmental conditions, and thrust requirement) for which the fan operation is designed. This can mean, for example, the conditions at which the fan (or the gas turbine engine) has optimum efficiency in terms of construction.

When in use, a gas turbine engine as described and claimed herein can operate at the cruise conditions defined elsewhere herein. Such cruise conditions can be determined by the cruise conditions (for example the mid-cruise conditions) of an aircraft to which at least one (for example 2 or 4) gas turbine engine can be fastened in order to provide the thrust force.

In the present case, the terms “feed” of the gearbox and “return” of the gearbox are each taken to mean the interface between the oil system of the gas turbine engine and the gearbox, in the respective regions of which oil is transferred or applied or discharged from the oil system to the gearbox to cool and/or lubricate consuming units of the gearbox.

Moreover, provision can also be made for oil coolers, oil tanks and the like to be provided or arranged in the flow path of the oil between the oil filter and the feed of the gearbox.

It is self-evident to a person skilled in the art that a feature or parameter described in relation to any one of the above aspects may be applied to any other aspect, unless they are mutually exclusive. Furthermore, any feature or any parameter described here may be applied to any aspect and/or combined with any other feature or parameter described here, unless they are mutually exclusive.

Embodiments will now be described by way of example with reference to the figures, in which:

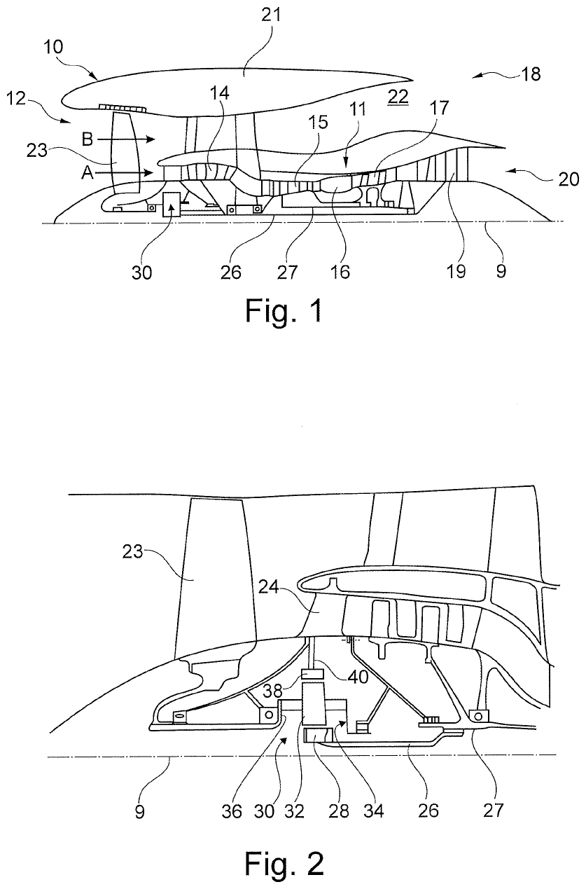

FIG. 1 shows a longitudinal sectional view of a gas turbine engine;

FIG. 2 shows an enlarged partial longitudinal sectional view of an upstream portion of a gas turbine engine;

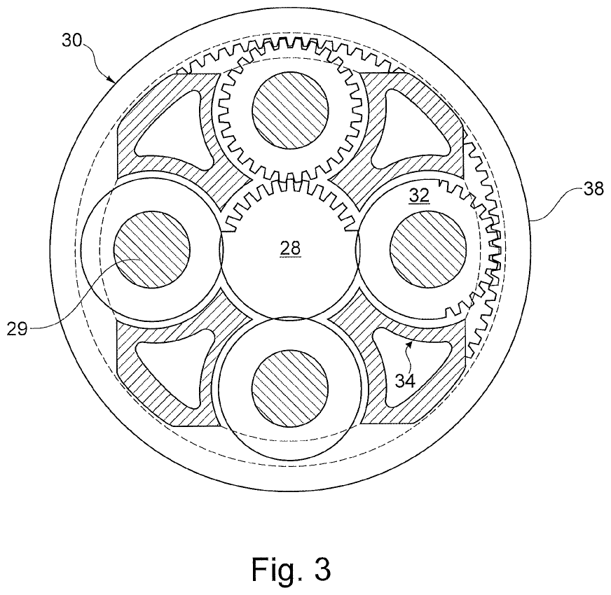

FIG. 3 shows an isolated illustration of a gearbox for a gas turbine engine; and

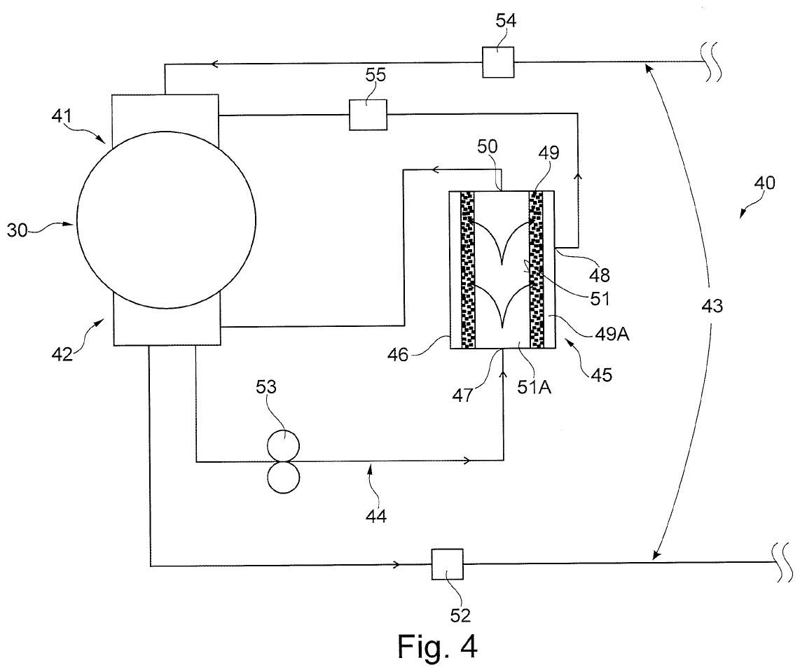

FIG. 4 to FIG. 9 each show a schematized partial illustration of various embodiments of an oil system of a gas turbine engine, via which in each case a gearbox can be supplied with oil.

FIG. 1 illustrates a gas turbine engine 10 or turbomachine with a primary axis of rotation 9. The engine 10 comprises an air intake 12 and a thrust fan 23 that generates two air flows: a core air flow A and a bypass air flow B. The gas turbine engine 10 comprises a core 11 or engine core which receives the core air flow A. In the sequence of axial flow, the engine core 11 comprises a low-pressure compressor 14, a highpressure compressor 15, a combustion device 16, a high-pressure turbine 17, a lowpressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. A fan 23 is attached to and driven by the low-pressure turbine 19 by way of a shaft 26 and an epicyclic gearbox 30. In this context, the shaft 26 is also referred to as a core shaft or connecting shaft.

During use, the core air flow A is accelerated and compressed by the lowpressure compressor 14 and directed into the high-pressure compressor 15, where further compression takes place. The compressed air expelled from the high-pressure compressor 15 is directed into the combustion device 16, where it is mixed with fuel and the mixture is combusted. The resultant hot combustion products then expand through, and thereby drive, the high-pressure and low-pressure turbines 17, 19 before being expelled through the nozzle 20 to provide some thrust force. The high-pressure turbine 17 drives the high-pressure compressor 15 by way of a suitable connecting shaft or shaft 27, which is also referred to as the core shaft. The fan 23 generally provides the majority of the propulsion force. The epicyclic gearbox 30 is a reduction gearbox.

An exemplary arrangement for a geared fan gas turbine engine 10 is shown in FIG. 2. The low-pressure turbine 19 (see FIG. 1) drives the shaft 26, which is coupled to a sun gear 28 of the epicyclic gearbox assembly 30. A plurality of planet gears 32, which are coupled to one another by way of a planet carrier 34, are situated radially outside the sun gear 28 and mesh with the latter, and are in each case disposed so as to be rotatable on carrier elements 29 that are connected in a rotationally fixed manner to the planet carrier 34. The planet carrier 34 limits the planet gears 32 to orbiting around the sun gear 28 in a synchronous manner while enabling each planet gear 32 to rotate about its own axis on the carrier elements 29. The planet carrier 34 is coupled by way of linkages 36 to the fan 23 so as to drive the rotation of the latter about the engine axis 9. Radially to the outside of the planet gears 32 and meshing therewith is an annulus or ring gear 38 that is coupled, via linkages 40, to a stationary supporting structure 24.

It is noted that the terms “low-pressure turbine” and “low-pressure compressor” as used herein may be taken to mean the lowest-pressure turbine stage and the lowest-pressure compressor stage (that is to say not including the fan 23) respectively and/or the turbine and compressor stages that are connected to one another by the connecting shaft 26 with the lowest rotational speed in the engine (that is to say not including the gearbox output shaft that drives the fan 23). In some literature, the “low-pressure turbine” and “low-pressure compressor” referred to herein may alternatively be known as the “intermediate-pressure turbine” and “intermediate-pressure compressor”. Where such alternative nomenclature is used, the fan 23 can be referred to as a first compression stage or lowest-pressure compression stage.

The epicyclic gearbox 30 is shown in greater detail by way of example in FIG. 3. Each of the sun gear 28, the planet gears 32 and the ring gear 38 comprise teeth about their periphery to mesh with the other gears. However, for clarity, only exemplary portions of the teeth are illustrated in FIG. 3. Although four planet gears 32 are illustrated, it will be apparent to the person skilled in the art that more or fewer planet gears 32 may be provided within the scope of protection of the claimed invention. Practical applications of an epicyclic gearbox 30 generally comprise at least three planet gears 32.

The epicyclic gearbox 30 illustrated by way of example in FIGS. 2 and 3 is of the planetary type, in which the planet carrier 34 is coupled to an output shaft via linkages 36, wherein the ring gear 38 is fixed. However, any other suitable type of epicyclic gearbox 30 may be used. By way of a further example, the epicyclic gearbox 30 may be a star arrangement, in which the planet carrier 34 is held so as to be fixed, wherein the ring gear (or annulus) 38 is allowed to rotate. In the case of such an arrangement, the fan 23 is driven by the ring gear 38. By way of a further alternative example, the gearbox 30 may be a differential gearbox in which the ring gear 38 and the planet carrier 34 are both allowed to rotate.

It will be appreciated that the arrangement shown in FIGS. 2 and 3 is only exemplary, and various alternatives are within the scope of protection of the present disclosure. Purely by way of example, any suitable arrangement may be used for positioning the gearbox 30 in the engine 10 and/or for connecting the gearbox 30 to the engine 10. By way of a further example, the connections (such as the linkages 36, 40 in the example of FIG. 2) between the gearbox 30 and other parts of the engine 10 (such as the input shaft 26, the output shaft and the fixed structure 24) may have a certain degree of stiffness or flexibility. By way of a further example, any suitable arrangement of the bearings between rotating and stationary parts of the engine (for example between the input and output shafts of the gearbox and the fixed structures, such as the gearbox casing) may be used, and the disclosure is not limited to the exemplary arrangement of FIG. 2. For example, where the gearbox 30 has a star arrangement (described above), the person skilled in the art would readily understand that the arrangement of output and support linkages and bearing positions would usually be different than that shown by way of example in FIG. 2.

Accordingly, the present disclosure extends to a gas turbine engine having an arbitrary arrangement of gearbox types (for example star-shaped or planetary), support structures, input and output shaft arrangement, and bearing positions.

FIG. 4 shows a highly schematized partial illustration of an oil system 40 of the gas turbine engine 10. The illustration in FIG. 4 includes both a feed 41 of the gearbox 10 and a return 42 of the gearbox 10. Via the feed 41 of the gearbox 30, oil can be supplied to the gearbox 30 from the oil system 40, while the oil supplied to the gearbox 30 can be fed back into the oil system 40 via the return 42 and can be supplied to the feed 41 of the gearbox 30 again via the oil system 40.

Here, the oil system 40 comprises a first oil circuit 43 and a second oil circuit 44, which are provided in parallel with each other between the return 42 and the feed 41 of the gearbox 30. In the present case, the return 42 of the gearbox 30 is connected to an oil filter 45 of the second oil circuit 44, in the region of which dirt particles can be filtered out of the oil introduced from the return 42 into the second oil circuit 44. Oil cleaned in the region of the oil filter 45 can be carried in the direction of the feed 41 of the gearbox 30 via the second oil circuit 44. To wash dirt particles out of the oil filter 45, oil additionally introduced into the oil filter 45 starting from the return 42 can be passed through the oil filter 45 and reintroduced into the return 42.

In the present case, the oil filter 45 comprises a hollow-cylindrical housing 46, which has an inlet 47. In the region of the inlet 47, the oil filter 45 is connected to the return 42. In addition, the housing 46 of the oil filter 45 has a first outlet 48, via which the housing 46 of the oil filter 45 is connected to the feed 41 of the gearbox 30. Arranged in the flow path of the oil flowing via the inlet 47 into the housing 46 of the oil filter 45 in the direction of the outlet 48, starting from the return 42 of the gearbox 46, is a filter medium 49, which is likewise of hollow-cylindrical design and, together with the housing 46, delimits an annular chamber 49A. Oil cleaned of dirt particles in the region of the oil filter 45 can be carried out of the annular chamber 49A in the direction of the feed 41 of the gearbox 30.

A further outlet 50 of the housing 46 of the oil filter 45 is effectively connected to the return 42 of the gearbox 30. Oil introduced into the housing 46 from the return 42 via the inlet 47 can be discharged from the oil filter 45 through an interior 51 delimited by the filter medium 49 and, from there, via the further outlet 50, from the housing 46 in the direction of the return 42 without having to flow through the filter medium 49. By means of the oil volume flow passed directly from the inlet 47 in the direction of the outlet 50, dirt particles accumulated on an inner side 51 of the filter medium 49 can be washed out of the oil filter 45 and carried back into the oil circuit or the return 42 of the gearbox 30.

In order to avoid an accumulation of dirt particles in the oil system 40, the first oil circuit 43 is embodied with a further oil filter 52, in the region of which oil supplied from the return 42 of the gearbox 30 is filtered. The dirt particles filtered out in the region of the further oil filter 52 remain permanently in the region of the further oil filter 52, which is serviced cyclically in order to avoid excessive pressure losses in the region of the further oil filter 52 due to excessive dirt particle loading.

In the present case, the second oil circuit 44 is designed with a pump 53, which draws in oil from the return 42 of the gearbox 30 in delivery mode and delivers it directly back into the gearbox 30 via the second oil circuit 44 in the illustrative embodiment of the oil system 40 or gas turbine engine 10 shown in FIG. 4. In the present case, the first oil circuit 43 corresponds substantially to a main oil circuit of the gas turbine engine 10, via which various regions of the gas turbine engine 10, which include the gearbox 30 and bearing units of the gas turbine engine 10, are supplied with oil.

In the present case, the pump 53 is driven via the gearbox 30, wherein the effective connection between the gearbox 30 and the pump 53 is of switchable design. In this case, the pump 53 is driven by the gearbox 30 only if an insufficient supply of oil is detected from the first oil circuit 43. Such an undersupplied operating state of the gearbox 30 from the first oil circuit 43 can be ascertained, for example, by way of a sensor 54, by means of which a feed pressure or a fluid volume flow in the feed 41 of the gearbox 30 or some other suitable operating variable of the gas turbine engine 10 can be determined.

In addition, provision can also be made for the switchable effective connection between the gearbox 30 and the pump 53 to be activated in accordance with further operating variables of the gas turbine engine 10, from which an undersupplied operating state of the gearbox 30 with oil from the first oil circuit 43 can be detected.

As a departure from this, provision can also be made for the pump 53 to be driven electrically, wherein the electric drive of the pump 53 is activated when required to the same extent as the mechanical effective connection between the gearbox 30 and the pump 53. In addition, there is also the possibility of embodying the second oil circuit 44 with a cooler 55 in order to control the temperature of the oil volume circulating through the oil circuit 44 to the desired extent.

In the illustrative embodiment of the oil system 40 shown in FIG. 4, the oil delivered by the oil pump 53 when the pump 53 is switched on is in part passed directly from the inlet 47 to the further outlet 50 and, during this process, is passed continuously through the oil filter 45 to wash out the dirt particles.

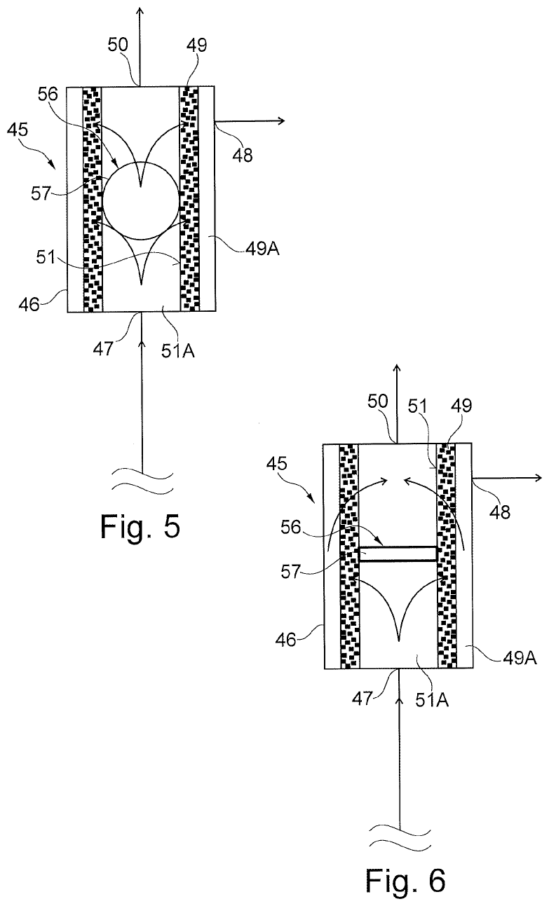

FIG. 5 shows an isolated illustration, corresponding to FIG. 4, of another embodiment of the oil filter 45, which has the construction described with reference to FIG. 4, apart from a valve unit 56 arranged within the filter medium 49. The valve unit 56 essentially comprises a disk-shaped valve element 57, the outside diameter of which is matched to the inside diameter of the filter medium 49 of the oil filter 45. In relation to the filter medium 49, the valve element 57 can be transferred between an operating state illustrated in FIG. 5, in which it opens the direct flow path between the inlet 47 and the further outlet 50, and a second operating state, which is shown in FIG. 6. In the second operating state, the disk-shaped valve element 57 blocks the direct flow path within the filter medium 49 between the inlet 47 and the further outlet 50 for the oil introduced into the oil filter 45.

Via the valve unit 56, there is now the possibility of washing out the inner side 51 of the filter medium 49 to the extent described with reference to FIG. 4 by means of an oil volume flow passed directly through the interior of the filter medium 49 from the inlet 47 in the direction of the further outlet 50 and of discharging dirt particles from the oil filter 45. For this purpose, the disk-shaped valve element 57 of the valve unit 56 is pivoted as required by a corresponding actuator mechanism of the oil filter 45 into the pivoted position shown in FIG. 5.

In order to increase the cleaning capacity of the oil passed through the oil filter 45, the disk-shaped valve element 57 is transferred by the actuator mechanism of the oil filter 45 into the pivoted position shown in FIG. 6, in which the direct flow path of the oil introduced into the oil filter 45 via the inlet 47 in the direction of the further outlet 50 is blocked by the disk-shaped valve element 57. The oil introduced into the interior 51A of the oil filter 45 via the inlet 47 is then forced first of all to flow completely out of the interior 51A of the oil filter 45 and through the filter medium 49 into the annular chamber 49A.

Following this, some of the oil flows out of the annular chamber 49A and out of the oil filter 45 via the outlet 48 in the direction of the feed 41 of the gearbox 30. The other part of the oil flowing into the annular chamber 49A flows back through the filter medium 49 into that part of the interior 51A which is connected to the further outlet 50. There is a higher probability that the oil volume flow flowing radially inwards through the filter medium 49 will flush dirt particles taken up by the filter medium 49 out of the oil filter 45 via the further outlet 50 in the direction of the return 42 than is the case when the oil flows directly through the interior 51A in the first operating state of the valve unit 56.

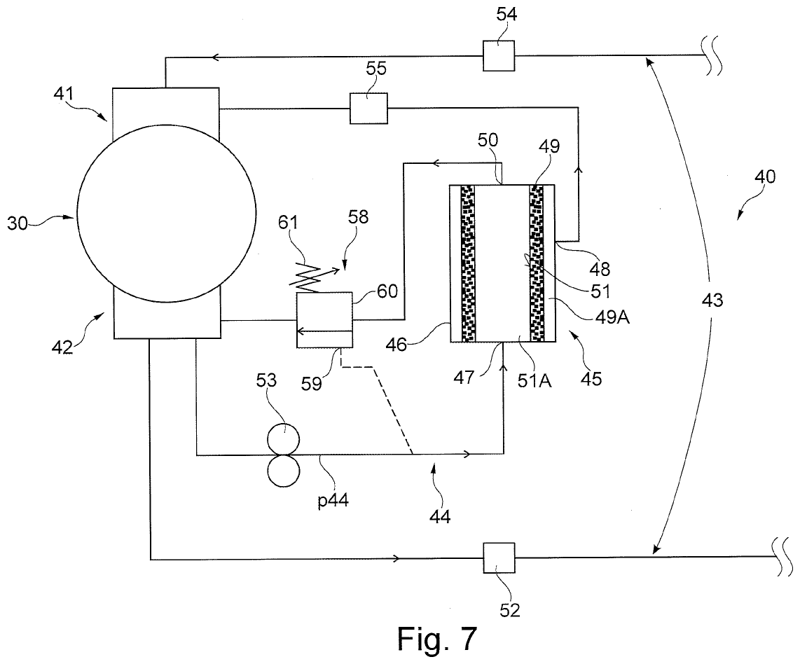

FIG. 7 shows an illustration, corresponding to FIG. 4, of another illustrative embodiment of the gas turbine engine 10, which comprises a valve unit 58 in the region between the further outlet 50 and the return 42 of the gearbox 30. Via the valve unit 58, oil for washing out dirt particles can be passed through the oil filter 45. In this case, it is possible, depending on a pressure p44 in the second oil circuit 44 of the oil system 40 between the return 42 of the gearbox 30 and the oil filter 40, for the valve unit 58 to be transferred to an operating state in which dirt particles can be filtered out of the oil in the oil filter 45 and, at the same time, oil can be passed through the oil filter 45 to wash out dirt particles. In addition, it is also possible for the valve unit 58 to be transferred by the pressure p44 to a further operating state, in which it is only possible in the region of the oil filter 45 to filter dirt particles out of the oil supplied to the oil filter 45 from the return 42 of the gearbox 30.

For this purpose, the valve unit 58 in the illustrative embodiment illustrated in FIG. 7 is embodied in such a way that it opens the effective connection between the further outlet 50 of the housing 46 and the return 42 of the gearbox 30 when a pressure threshold of the pressure p44 is reached, and blocks said effective connection below the pressure threshold. This ensures that a high loading of the filter medium 49 with dirt particles, which is associated with a high pressure loss in the region of the oil filter 45, is avoided or reduced in a simple manner, without a high outlay on open-loop and closed-loop control, by opening the valve unit 58, this being associated in turn with washing out of the dirt particles.

For this purpose, the pressure p44 is applied to a control surface 59 of a valve spool 60 of the valve unit 58. The pressure force resulting from the pressure and acting on the valve spool 60 counteracts a spring force of a spring 61 likewise acting on the valve spool 60. In the present case, the spring force of the spring 61 can be changed in accordance with the operating state, thus enabling a response of the valve unit 58 to be varied in accordance with the operating state. However, depending on the respective application, there is also the possibility of embodying the valve unit 58 with a spring whose spring force cannot be varied.

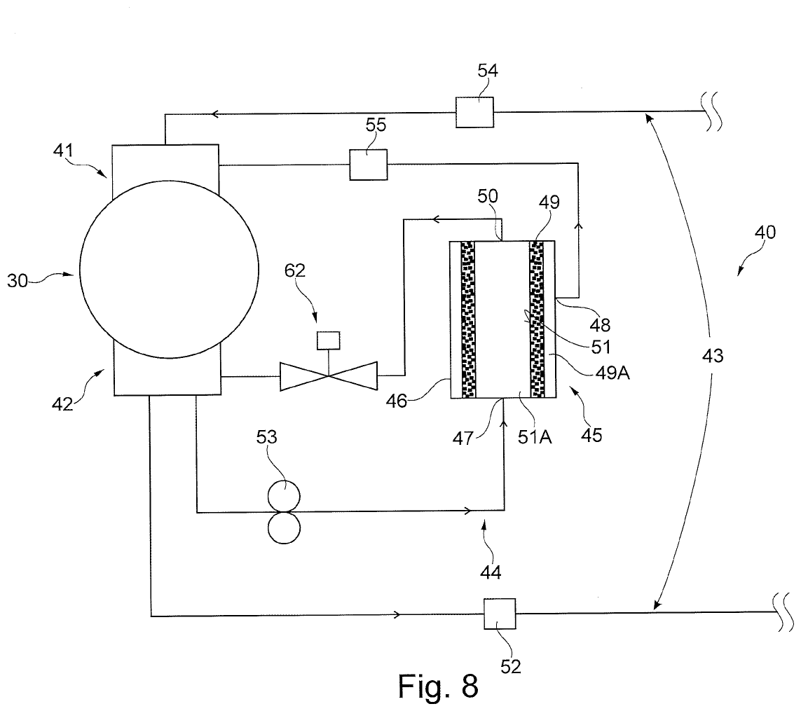

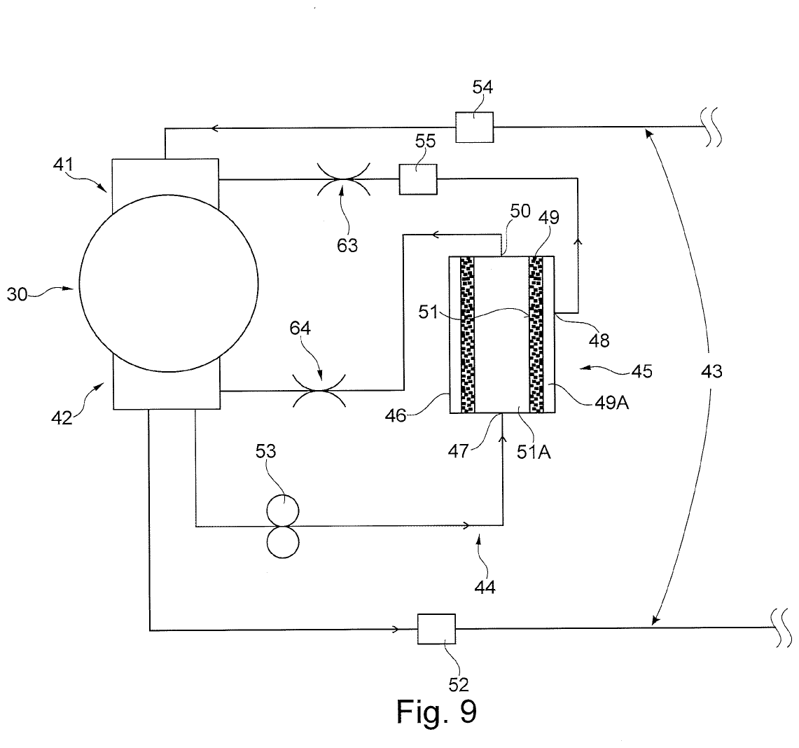

FIG. 8, in turn, shows an illustration corresponding to FIG. 4 of the oil system 40, which is embodied in the region between the further outlet 50 of the oil filter 45 and the return 42 of the gearbox 30 with a valve unit 62, via which, in turn, a direct flow through the oil filter 45, starting from the inlet 47, in the direction of the return 42 can be enabled or blocked.

Here, the valve unit 62 can be actuated under time and/or logic control in accordance with the respective application. This means that the valve unit 62 opens the connection between the further outlet 50 and the return 42 of the gearbox 30, e.g. in each case after the expiry of a defined operating time, for a predefined flushing time, within which dirt particles can be washed or flushed out of the oil filter 45 in the direction of the return 42 via the further outlet 50. As an alternative thereto or in addition thereto, there is once again also the possibility of transferring the valve unit 62 into the blocking or enabling operating state thereof when predefined operating states of the gas turbine engine 10 are detected. Such operating states can be, for example, a defined operating temperature, defined oil requirements of the gearbox 30 or even current operation of an aircraft constructed with the gas turbine engine 30, e.g. a flight or a ground operation mode.

FIG. 9 furthermore shows an illustration corresponding to FIG. 4 of the oil system 40, which differs from the oil system 40 shown in FIG. 4 in the region of the second oil circuit 44. The second oil circuit 44 comprises a restriction device 63 and 64, respectively, both in the connecting region between the outlet 48 and the feed 41 of the gearbox 30 and in the connecting region between the further outlet 50 and the return 42 of the gearbox 30. In accordance with the respective flow cross sections specified in the region of the restriction device 63 and 64 and with the associated flow resistances, it is possible to define or adjust the portion of the oil volume flow introduced into the oil filter 45 via the inlet 47 which is passed in the direction of the feed 41 and the further portion, which flows out of the oil filter 45 in the direction of the return 42, in addition to the pressure loss of the filter medium 49.

Depending on the respective application, there is the possibility of providing only restriction device 63, only restriction device 64 or, as illustrated in FIG. 9, both restriction devices 63 and 64. Moreover, there is the possibility of embodying the restriction devices 63 and 64 as constant restrictors, as illustrated in FIG. 9, or alternatively of configuring at least one of the restriction devices 63 or 64 as an adjustable restriction device. The distribution factor of the supplied oil volume flow in the direction of the feed 41 and in the direction of the return 42 can then be varied in accordance with the operating state.

### LIST OF REFERENCE SIGNS

9 Primary axis of rotation
10 Gas turbine engine
11 Core
12 Air intake
14 Low-pressure compressor
15 High-pressure compressor
16 Combustion installation
17 High-pressure turbine
18 Bypass thrust nozzle
19 Low-pressure turbine
20 Core thrust nozzle
21 Engine nacelle
22 Bypass duct
23 Fan
24 Support structure
26 Shaft, core shaft
27 Shaft
28 Sun gear
29 Carrier element
30 Gearbox
32 Planet gear
34 Planet carrier
36 Linkage
38 Ring gear
40 Oil system
41 Feed of the gearbox
42 Return of the gearbox
43 First oil circuit of the oil system
44 Second oil circuit of the oil system
45 Oil filter
46 Housing of the oil filter
47 Inlet of the housing of the oil filter
48 Outlet of the housing of the oil filter
49 Filter medium
49A Annular chamber of the oil filter
50 Further outlet of the housing of the oil filter
51 Inner side of the filter medium
51A Interior of the filter medium
52 Further oil filter
53 Oil pump
54 Sensor
55 Oil cooler
56 Valve unit
57 Disk-shaped valve element of the valve unit 56
28 Valve unit
59 Control surface of the valve unit 58
60 Valve spool of the valve unit 58
61 Spring of the valve unit 58
62 Valve unit
63, 64 Restriction device
A Core air flow
B Bypass air flow
p44 Pressure

1. A gas turbine engine for an aircraft having a gearbox that can be supplied with oil via an oil system, wherein the oil supplied to the gearbox can be fed back into the oil system via a return of the gearbox and can be supplied to a feed of the gearbox again via the oil system, wherein the oil system has an oil filter between the return and the feed of the gearbox for the purpose of filtering dirt particles out of the oil introduced into the oil system from the return, wherein oil cleaned in the region of the oil filter can be carried in the direction of the feed of the gearbox, and wherein oil can be passed through the oil filter to wash dirt particles out of the oil filter.

2. The gas turbine engine according to claim 1, wherein the oil system is embodied in such a way that the oil for washing out the dirt particles can be passed continuously and/or discontinuously through the oil filter.

3. The gas turbine engine according to claim 1, wherein a valve unit is provided, by means of which oil can be passed through the oil filter to wash out dirt particles.

4. The gas turbine engine according to claim 3, wherein, depending on a pressure in the oil system between the return of the gearbox and the oil filter, the valve unit can be transferred to an operating state in which dirt particles can be filtered out of the oil in the oil filter and oil can be passed through the oil filter to wash out dirt particles, and to a further operating state, in which it is only possible in the region of the oil filter to filter dirt particles out of the oil supplied to the oil filter from the return of the gearbox.

5. The gas turbine engine according to claim 3, wherein the valve unit can be transferred under time and/or logic control to an operating state in which dirt particles can be filtered out of the oil in the oil filter and oil can be passed through the oil filter to wash out dirt particles, and to a further operating state, in which it is only possible in the region of the oil filter to filter dirt particles out of the oil supplied to the oil filter from the return of the gearbox.

6. The gas turbine engine according to claim 1, wherein a restriction device is provided between the oil filter and the return and/or between the oil filter and the feed of the gearbox.

7. The gas turbine engine according to claim 1, wherein the oil system has an oil pump downstream of the return of the gearbox and upstream of the oil filter.

8. The gas turbine engine according to claim 1, wherein the gearbox can also be supplied with oil via a part of the oil system via which oil can be passed from the return of the gearbox to the feed of the gearbox in parallel with that part of the oil system which includes the oil filter.

9. The gas turbine engine according to claim 1, wherein the oil filter is arranged at least partially within a housing of the gearbox.

10. The gas turbine engine according to claim 1, wherein the oil filter is arranged outside a housing of the gearbox.

11. The gas turbine engine according to claim 1, wherein the oil filter comprises a housing, in which a filter medium is arranged between an inlet of the housing, which is connected to the return of the gearbox, and an outlet of the housing, which is connected to the feed of the gearbox, wherein the housing comprises a further outlet, via which oil for washing dirt particles out of the filter medium can be discharged from the housing.

12. The gas turbine engine according to claim 1, wherein the oil volume flow, by means of which dirt particles can be discharged from the oil filter, can be introduced into the return of the gearbox starting from the oil filter.

13. The gas turbine engine according to claim 1, wherein the oil system is designed in such a way that the oil volume flow to be passed through the oil filter to wash out dirt particles can be supplied to the oil filter at least partially starting from the return of the gearbox.

14. The gas turbine engine according to claim 1, wherein an engine core, which comprises a turbine, a compressor and a core shaft connecting the turbine to the compressor, is provided, wherein a fan, which is positioned upstream of the engine core, comprises a plurality of fan blades, and the gearbox receives an input from the core shaft and outputs drive for the fan in order to drive the fan at a lower speed than the core shaft.

15. The gas turbine engine according to claim 14, wherein the turbine is a first turbine, the compressor is a first compressor, and the core shaft is a first core shaft, wherein the engine core furthermore comprises a second turbine, a second compressor and a second core shaft, which connects the second turbine to the second compressor, and wherein the second turbine, the second compressor and the second core shaft are arranged so as to rotate at a higher speed than the first core shaft.
